(19) United States
(12) Patent Application Publication
(10) Pub. No.: US 2006/0124402 A1
(43) Pub. Date: Jun. 15, 2006

(54) Pneumatically actuated disc brake having an adjustment device

(75) Inventors: Dieter Bieker, Oberaudorf (DE); Johann Baumgartner, Moosburg (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 10/528,761

(22) PCT Filed: Sep. 23, 2003
(86) PCT No.: PCT/EP03/10554

§ 371 Date: Nov. 15, 2005

(30) Foreign Application Priority Data
Sep. 23, 2002 (DE) 102 44 152.9
Sep. 12, 2003 (DE) 103 42 281.1

(51) Int. Cl. F16D 55/00

(52) U.S. Cl. 188/71.1; 188/79.51

(57) ABSTRACT

The invention relates to a pneumatically actuated disc brake for utility vehicles, said disc brake comprising a single-part or multi-part caliper which overlaps a brake disc and can be pivoted or displaced in relation to a wheel axis or a wheel hub, an application device which is arranged in the caliper and is used to apply the brake, and an adjustment device. The invention is characterized in that the adjustment device comprises at least one adjustment unit that can be directly actuated by means of compressed air, independently from the application device.

### BACKGROUND AND SUMMARY OF THE INVENTION

The invention relates to a disc brake and, in particular, to a disc brake for utility vehicles.

From European Patent document EP 0 688 404 B1, a sliding-caliper disc brake is known, in the case of which an application device with a rotary lever is arranged on one side of the caliper. The rotary lever is disposed to be swivellable about an axis of rotation extending parallel to the plane of the brake disc. Facing the brake disc, this rotary lever rests against a traverse or beam by means of an eccentric, which traverse is slidably guided with respect to the brake disc. In the traverse, two adjusting spindles equipped with an external thread are adjustably screwed in a parallel arrangement. The adjusting device has a mechanical adjusting mechanism, which is coupled with the rotary lever.

It is also known to not couple the adjusting device with the rotary lever but to use an electric motor as the drive of the adjusting device. One or more electric motors are particularly advantageous as a drive for the adjusting device if two adjusting devices are to be arranged on one side of the brake disc or if in each case one or two adjusting devices are to be arranged on both sides of a brake disc, because it becomes possible by way of an electronic controlling of the motors to mutually easily synchronize the adjusting movements of the individual adjusting devices.

It is an object of the invention to create another alternative for coupling the adjusting device with the application movement of the rotary lever and for the electromotive actuation of the adjusting device. In particular, it should also be possible, in the case of a disc brake with more than one adjusting rotating device, to mutually synchronize these adjusting devices in a particularly simple constructive manner.

The invention achieves this task by providing a pneumatically actuated disc brake, particularly for utility vehicles, having a single-part or multipart caliper, which straddles a brake disc and can be swivelled or displaced relative to a wheel axle or wheel hub, an application device arranged in the caliper for applying the brake, at least one adjusting device for compensating brake pad wear, wherein the adjusting device has at least one adjusting unit, which unit can be actuated independently of the application device directly via compressed air. Accordingly, it is provided that the adjusting device has at least one adjusting unit which can be actuated independently of the application device directly by means of compressed air.

The compressed-air actuation of the adjusting device makes an electric connection to the disc brake unnecessary although, in principle, it is also contemplated to connect the pneumatic actuation with an electronic control device, either only, for example, for monitoring the wear of the brake pads or for electronically “intelligent” control of the actuating of the adjusting units.

Expediently, the caliper is constructed as a fixed caliper and the brake disc is axially movably constructed at least in the area of its friction ring surface or is displaceably arranged on a wheel axle. In particular, the brake disc is constructed in a constructively simple manner to be axially movable only by the path of the working stroke at least in the area of its friction ring or is displaceably arranged on a wheel axle.

At least one (preferably two) of the pneumatically operable adjusting units is advantageously arranged on both sides of the brake disc, several of the adjusting units being in a mutually operative connection via compressed-air pipes or passages. This saves a synchronization with movable parts through use of a mechanism, although it can be optionally implemented. In particular, it is also easily contemplated to mutually synchronize the adjusting units arranged on the opposite sides of a brake disc.

According to a particularly preferred embodiment, the adjusting movements are carried out during pauses between brakings by ventilating the pressure chambers of the adjusting devices. Here, it is advantageous for the plunger rod and the piston of each adjusting unit to be non-rotatable relative to one another during application movements and to be rotatable relative to one another during adjusting movements.

Advantageous further developments of the invention are described and claimed herein.

### BRIEF DESCRIPTION OF THE DRAWINGS

FIG. 1 is a sectional view taken perpendicular to the brake disc plane of a disc brake according to the invention;

FIG. 2 is another sectional view perpendicular to the sectional view of FIG. 1 of the disc brake of FIG. 1 with brake pads being illustrated in an unworn condition in the left part of the figure and in a worn condition in the right part of the figure;

FIG. 3 is an enlarged cutout view of an adjusting unit in the case of new brake pads; and

FIG. 4 is a view of the adjusting unit of FIG. 3 in the operating position corresponding to worn brake pads.

### DETAILED DESCRIPTION OF THE DRAWINGS

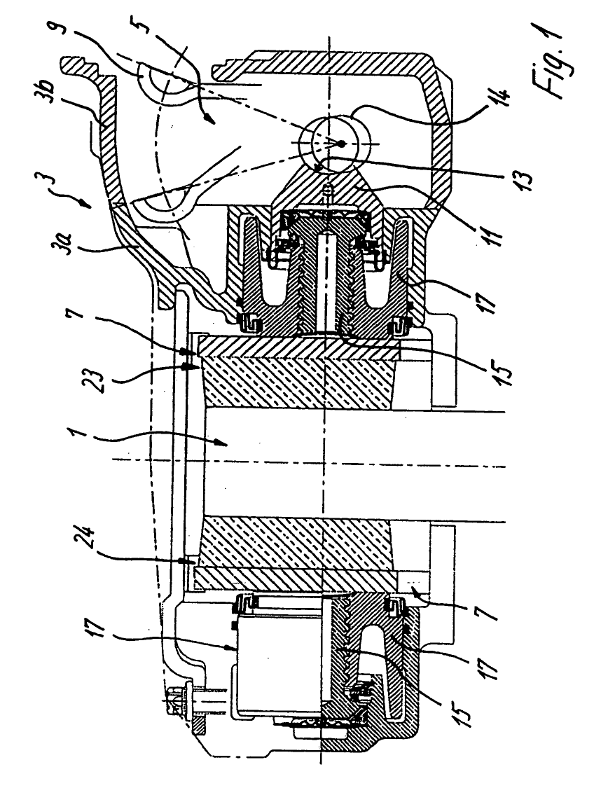

FIG. 1 is a sectional view of a pneumatically actuated fixed-caliper disc brake with a two-part caliper 3, which straddles a brake disc 1 displaceably arranged on the wheel axle (not shown). The two caliper parts 3a, 3b are preferably mutually connected by way of studs not visible here. The first caliper part 3a frames the brake disc 1 in its upper circumferential area, and the second caliper part 3b is used for accommodating the brake application device 5.

As an alternative, the caliper 3 can also be constructed in one piece (not shown here). The principle of the fixed caliper is to be understood as a particularly preferred embodiment. However, in principle, the pneumatically actuated adjusting system is also suitable for disc brakes, for example, with a sliding caliper or a swivelling caliper.

Toward the brake disc 1, one brake pad shaft 7, respectively, is constructed in the caliper parts 3a, 3b on both sides of the brake disc. A piston 17 in the caliper extends into the brake pad shafts 7.

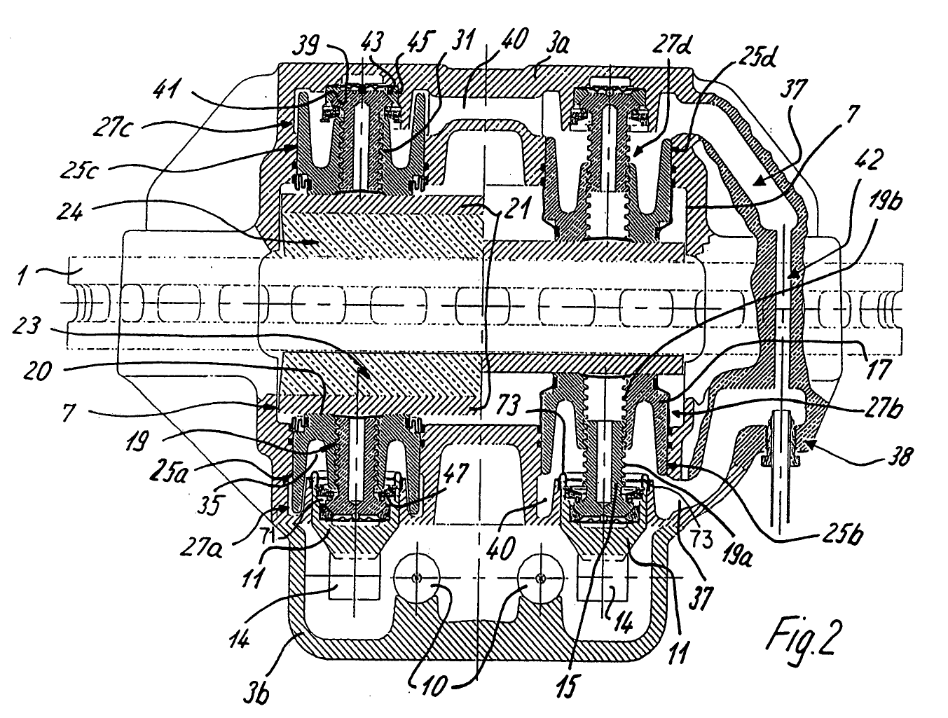

The brake application device 5 has an eccentric rotary lever 9 (which is only outlined here) and which can be actuated by a piston rod (not shown) of a pneumatically operated compressed-air cylinder. The eccentric rotary lever 9 is supported on the caliper 3, for example, by way of bearing elements, such as balls 10 outlined in FIG. 2 and additional slide bearing shells, or by way of a roller (also not shown). On its side facing away from the caliper 3, the rotary lever 9 acts at a center point or, as illustrated in FIG. 2, at two traverse-type lateral ends in each case upon an intermediate or supporting element 11. At its end facing the rotary lever, the supporting element 11 has a semicylindrical recess 13 in which an eccentric roller-type attachment of the rotary lever 9 engages, or in which a pressure roller 14 engages which is arranged between the recess 13 and the rotary lever 9 eccentrically with respect to the axis of rotation of the rotary lever 9.

The intermediate or supporting elements 11 are supported by way of additional elements to be explained in detail in each case on faces of plunger rods 15 equipped with an external thread 19a. Onto the plunger rods 15, the piston 17 is screwed which, in each case, is provided with an internal thread 19b. The thread 19 between the plunger rod 15 and the piston 17 is designed, in each case, to be non-selflocking.

At the ends facing away from the rotary lever 9, the pistons 17 each have a pressure surface, which serves as a pressure piece and rests on a brake pad holding plate 21 of the application-side brake pad 23.

When the rotary lever 9 is swivelled by advancement of the piston rod (not shown) of a compressed-air brake cylinder, the lower eccentric-type end (not visible here) of the rotary lever 9 causes an advancing of the intermediate element 11 in the direction of the brake disc 1. In this case, the plunger rods 15 and the pistons 17 are in each case pressed jointly in the direction of the brake pad 23, and the application-side brake pad 23 is displaced in the direction of the brake disc 1. With a progressing application movement, the brake disc 1 is then displaced on the wheel axle in the direction of the reaction-side brake pad 24 until the brake disc 1 rests on the reaction-side brake pad 24.

The pistons 17 are each axially movably inserted in a recess 25 in the caliper 3.

Here, the adjustment of the release play takes place on both sides of the brake disc 1 in each case by the use of two pneumatically operated adjusting units 27a-d, which are each arranged parallel with respect to one another and are constructed as adjusting rotary drives that can be operated pneumatically independently of the brake application unit.

Two of the total of four adjusting units 27a and 27b, as well as 27c and 27d) are arranged on the side of the brake disc 1 facing away from the brake application device, i.e., the reaction side, in the caliper 3. Also, these adjusting rotary drives 27c and 27d each have a plunger rod 15 and a piston 17 and permit compensation of the release play on the reaction side of the disc brake.

Since two adjusting units (27a and b, as well as c and d) are arranged on each face of the brake disc 1, it becomes possible to construct the brake disc 1, for example, as a sliding disc whose displacement path is dimensioned such that, via the sliding, less than the maximum adjusting path, and in particular even only the maximal working stroke during the application of the brake, can be bridged. This is because the brake pad wear is compensated by the adjusting units 27 arranged on both sides of the brake disc.

In contrast to the known adjusting units for pneumatic disc brakes actuated by a brake application device with an eccentric rotary lever, the adjusting units of the present invention are not co-actuated indirectly by way of an element of the brake application device, for example, by way of the rotary lever 9, but rather are actuated directly pneumatically or by the use of compressed air independently of the actual brake application device.

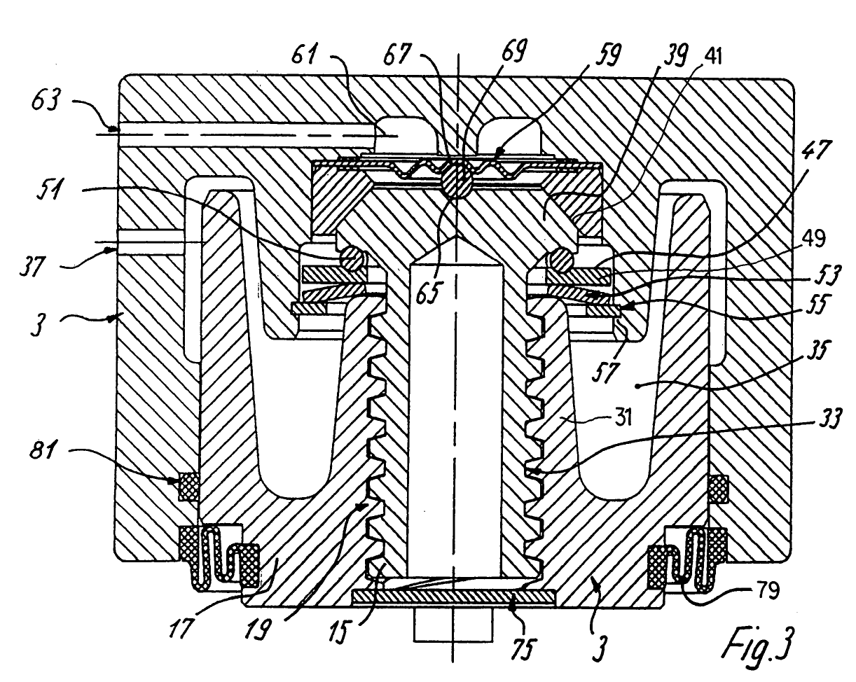

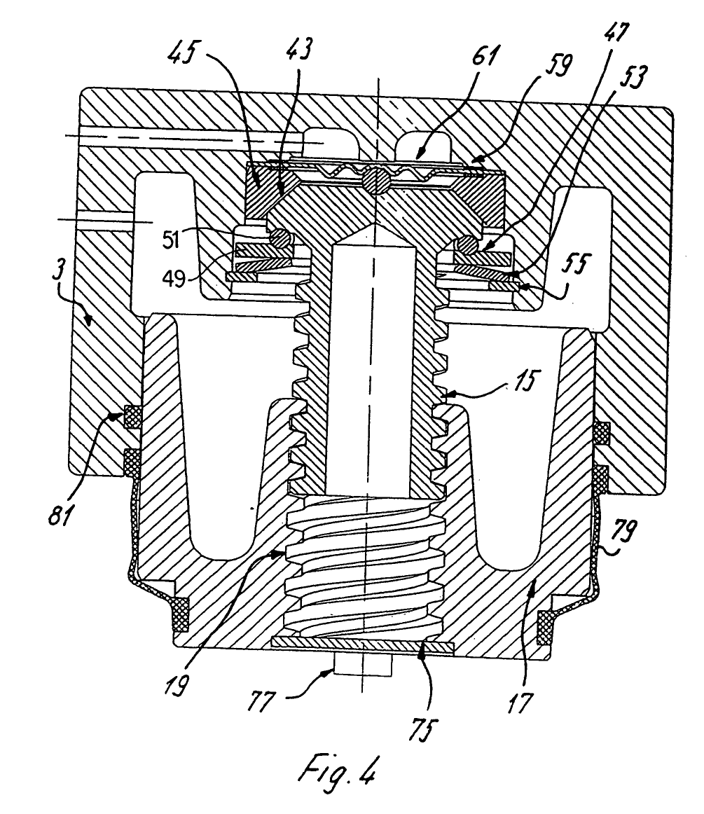

For this purpose, the adjusting units 27a-d each have the construction illustrated in an enlarged manner in FIGS. 3 and 4.

In each case, one of the pistons 17 having an (essentially or generally) U-shaped cross-section is inserted in recesses 25a-d in the caliper 3. The base side of the U-shaped piston 17 points toward the brake disc 1. Toward the interior, the piston 17 has a center attachment 31 which, in turn, has a bore 33 provided with an internal thread, into which bore 33 the plunger rod 15 is screwed.

On the side of the piston 17 facing away from the base side of the U, the recess 25 is designed such that, in each case, a pressure chamber 35 is constructed in the caliper or between the intermediate elements 11 and the pistons 17. On both sides of the brake disc, a compressed-air feed pipe 37, for example a bore constructed in the caliper 3, leads into the pressure chamber 35.

The compressed-air feed pipes 37 lead to a compressed-air connection 38 on the outside of the caliper 3 illustrated in FIG. 2.

According to FIGS. 1 and 2, the pressure chambers 35a and 35b, as well as 35c and 35d, of the two application-side and reaction-side adjusting units are in an operative connection with one another, for example via passages 40 between the pressure chambers 35 on each side of the brake pad as well as by way of a compressed-air pipe 42 from the application side to the reaction side of the disc brake, which leads into the compressed-air feed pipes 37. In this manner, the pistons 17a-d of the adjusting units 27a-d are jointly acted upon by compressed air.

During brakings, the piston 17 and the plunger rod 15 of each adjusting unit 27a-d are displaced without any relative rotation with respect to one another jointly in the direction of the brake disc 1.

In contrast, in the case of a release play adjustment, the pressure chamber 35 of the adjusting unit is ventilated, which presses the piston 17 in the direction of the brake disc. Simultaneously, it is achieved by a rotation of the plunger rod 15 that the piston 17 on the plunger rod 15 moves axially in the direction of the brake disc 1 in order to adjust the release play or carry out an adjustment.

The effect of the advancing of the piston 17 on the plunger rod 15 is illustrated by a comparison between FIG. 3 and FIG. 4. Thus, in comparison to FIG. 3, in FIG. 4, the piston 17 was moved in the direction of the brake disc 1, which compensates the wear of the brake pad 23. The analogous situation exists for the right part of FIG. 2 in comparison to the left part of this figure.

In order to implement the non-rotatability between the plunger rod 15 and the piston 17, as well as the relative rotatability during the adjusting movement, the adjusting units 27a-d each have additional elements.

Thus, as illustrated in FIG. 3, the plunger rod 15 is equipped with a ring attachment 39 at its end facing away from the brake disc 1. The ring attachment 39 has a conical surface 41 on the face pointing away from the brake disc 1, which conical surface 41 is supported on a correspondingly developed conical surface 43 of a support bearing ring 45, which is supported on the application side on the intermediate element 11 and at the reaction side on the caliper 3.

Between the conical surfaces 41, 43, a (micro) toothing is constructed, which is not shown here, so that the plunger rod 15 is non-rotatable relative to the support bearing ring 45 when it is supported on the support bearing ring 45. When force is introduced against the cone (thus, in the braking condition), in this manner the plunger rod 15 is prevented from rotating. When the piston 17 is also secured here against a rotation, the full braking pressure can be introduced because the piston 17 and the plunger rod 15 are blocked with respect to one another.

On its flat face facing away from the cone 41, the ring attachment 39 is, in each case, supported on a thrust bearing 47, which here consists in each case of a disc 49 and several balls 51 arranged between the disc 49 and the corresponding face of the ring attachment 39. On its side facing away from the balls 51, the disc 49 rests against a cup spring 53 which, in turn, on its side facing away from the disc 49, is supported on a retaining ring 55. The retaining ring 55 engages in a surrounding groove 57 in the caliper 3 or the intermediate element 11 and is axially fixed in this manner.

This arrangement operates as follows.

During an adjustment for brake pad wear, the pressure chambers 35 of the adjusting units 27 are jointly ventilated after a braking. As mentioned above, in this case, the piston 17 is pressed in the direction of the brake disc 1. Likewise, the piston presses the plunger rod 15, because of the non-selflocking thread 19 constructed between the two elements, along in the direction of the brake disc 1, which releases the plunger rod 15 from the toothing between the conical surfaces 43, 45.

On the other hand, the axial movement of the plunger rod 15 in the direction of the brake disc 1 is limited by the thrust bearing 47 supported on the retaining ring 55, so that the plunger rod 15 starts to rotate on the thrust bearing 47. This screws the plunger rod 17 forward in the direction of the brake pad.

The size of the release play has to be taken into account in the axial thread play in the case of the height of the toothing and when limiting the spring travel of the cup spring.

In each adjusting unit 27a-27d, a metal membrane 59 and at least one seal is arranged axially behind the axial end of the plunger rods 15 facing away from the brake disc in the area behind the support bearing rings. Behind the metal membrane 59, a second pressure chamber 61 is also constructed in the caliper 1 as an axial lengthening of the plunger rod. Another compressed-air feed pipe 63 in the caliper 3 leads into the pressure chamber 61 in the caliper, which compressed-air feed pipe 63 is connected, for example, with another compressed-air connection on the exterior side of the caliper. Between the corrugated metal membrane 59 and the plunger rod 15, a ball 69 is also arranged which engages in a centric recess 65 on the face of the plunger rod 15 and in a centric recess 67 of the metal membrane 59.

When a brake pad is changed, the second pressure chamber 61 is ventilated which, in turn, lifts the plunger rod 15 off the support bearing ring, so that the plunger rod 15 can be smoothly rotated, which permits the pushing back of the pistons 17 in the direction of the caliper 1 during a change of the brake pad. It is contemplated to activate the second compressed-air connection for safety reasons only in the event of a servicing or to connect it to a compressed-air supply.

On their side facing the brake disc 1, the intermediate elements 11 each have a cylindrical recess 71 for receiving the ends of the plunger rods 15 facing away from the brake disc and the elements with the reference numbers 39 to 69 on the application side of the brake disc.

The elements of the adjusting units 27a and 27b, as well as 27c and 27d, have an identical construction with the exception of the pressure rollers 14 and the intermediate elements 11 to the eccentric rotary lever on the application side of the disc brake. It is important that the intermediate element 11 is secured with respect to rotation, for example, by the pressure rollers 14.

The following additional elements of the adjusting unit 27a and 27b and/or 27c and 27d, should also be mentioned.

Between the ends of the intermediate elements 11 facing the brake disc and the caliper walls receiving the intermediate elements, for sealing-off the pressure chamber 35a, 35b, one set of roller bellows 73 respectively is arranged, so that an axial displacement of the intermediate elements 11 in the caliper 3 can be implemented.

The bore 33 in the piston 17 is closed off by way of a sealing washer 75 on the side facing the brake pads.

The antirotation protection for the pistons 17 is in each case implemented by corresponding devices for the antirotation protection between the brake pad holding plates and the pistons 17; for example, by the use of a non-cylindrical projection at the intermediate element, which form-lockingly engages in a corresponding recess (not shown here) in the assigned brake pad holding plate 21.

A roller-bellows-type or expansion-bellows-type cap 79 is used for covering the gap between the circumference of the pistons 17 and the caliper 3 on the end areas of the pistons 17 facing the brake disc.

A surrounding sealing ring 81 for sealing-off the pressure chamber 35 is in each case also arranged in the gap.

### TABLE OF REFERENCE NUMBERS

brake disc 1
caliper 3
caliper parts 3a, 3b
brake application device 5
opening 7
rotary lever 9
balls 10
intermediate or supporting element 11
recess 13
pressure roller 14
plunger rod 15
piston 17
thread 19
external thread 19a
internal thread 19b
pressure surface 20
brake pad holding plate 21
brake pad 23
recess 25
adjusting units 27a-d
center attachment 31
bore 33
pressure chamber 35
compressed-air feed pipe 37
compressed-air connection 38
ring attachment 39
passages 40
conical surface 41
compressed-air pipe 42
conical surface 43
support bearing ring 45
thrust bearing 47
disc 49
balls 51
cup spring 53
retaining ring 55
surrounding groove 57
metal membrane 59
second pressure chamber 61
compressed-air feed pipe 63
recess 65
recess 67
ball 69
recess 71
roller bellows 73
sealing washer 75
projection 77
cap 79
sealing ring 81

1-30. (canceled)

31. A pneumatic disc brake for utility vehicles, comprising:
a caliper straddling a brake disc;
a brake application device arranged in the caliper;
at least one adjusting device to compensate for brake pad wear; and
wherein the at least one adjusting device has at least one adjusting unit, said unit being actuated independently of the brake application device and directly via compressed air.

32. Disc brake according to claim 31, wherein the caliper is a fixed caliper and the brake disc is axially movable at least in an area of its friction ring surface.

33. Disc brake according to claim 31, wherein the brake disc is axially movable only by a working stroke path at least in an area of its friction ring surface.

34. Disc brake according to claim 31, wherein at least one of the pneumatically operable adjusting units is arranged on each side of the brake disc.

35. Disc brake according to claim 34, wherein two of the pneumatically operable adjusting units are arranged on each side of the brake disc.

36. Disc brake according to claim 31, wherein pressure chambers of multiple adjusting units are in an operative connection with one another by way of compressed-air passages.

37. Disc brake according to claim 31, wherein the brake application device includes an eccentric rotary lever having two traverse-type lateral ends that act upon one intermediate element, respectively, and further wherein the which intermediate elements having a recess on their side facing the brake disc.

38. Disc brake according to claim 37, wherein the intermediate elements are displaceably guided in the caliper.

39. Disc brake according to claim 37, wherein the intermediate elements are supported by way of plunger rods on pistons that are axially movable in the caliper.

40. Disc brake according to claim 39, wherein each piston has a pressure surface at an end facing away from the rotary lever, which pressure surface rests on a brake pad holding plate.

41. Disc brake according to claim 31, wherein each adjusting unit includes one piston and one plunger rod, which are screwed to one another by way of a non-selflocking thread.

42. Disc brake according to claim 41, wherein the plunger rod and the piston of each adjusting unit are non-rotatable relative to one another during brake application movements and are rotatable relative to one another during wear adjusting movements.

43. Disc brake according to claim 39, wherein the pistons are each inserted in a recess in the caliper.

44. Disc brake according to claim 43, wherein the pistons have a generally U-shape construction, a base side of the U-shape pointing toward the brake disc, and further wherein each piston has an interior center attachment, which center attachment has a bore provided with an internal thread, into which bore the plunger rod is screwed.

45. Disc brake according to claim 44, wherein on a piston side facing away from the base side, in each case, a pressure chamber is formed in the caliper or between the intermediate elements and the piston.

46. Disc brake according to claim 45, further comprising a compressed-air connection located at the caliper.

47. Disc brake according to claim 42, wherein the plunger rod of each adjusting unit is equipped with a ring attachment at an end facing away from the brake disc, which ring attachment has a conical surface on a face pointing away from the brake disc, and further wherein the conical surface is supported on a correspondingly developed conical surface of a support bearing ring.

48. Disc brake according to claim 47, wherein a toothing is arranged between the conical surfaces.

49. Disc brake according to claim 47, wherein the ring attachment, on an opposite side from the conical surface, is supported on a thrust bearing, which thrust bearing, on its side facing away from the ring attachment, rests on a cup spring and is axially displaceable to a limited extent.

50. Disc brake according to claim 49, wherein on its side facing away from the thrust bearing, the cup spring is supported on a retaining ring, which retaining ring engages in a surrounding groove in one of the caliper and the intermediate element.

51. Disc brake according to claim 48, wherein a second pressure chamber for releasing the toothing between the conical surfaces for restoring the pistons during a brake pad change is assigned to each adjusting unit.

52. Disc brake according to claim 51, further comprising a metal membrane arranged axially behind an axial end of the plunger rod facing away from the brake disc in an area behind a support bearing ring, which metal membrane bounds the second pressure chamber.

53. Disc brake according to claim 52, wherein a compressed-air feed pipe in the caliper leads into the second pressure chamber in the caliper, which compressed-air feed pipe is connected with another compressed-air connection on an exterior side of the caliper.

54. Disc brake according to claim 52, wherein between the metal membrane and the plunger rod, a ball is arranged which engages in a centric recess on the face of the plunger rod and into a centric recess of the metal membrane.

55. Disc brake according to claim 31, wherein multiple adjusting units are provided, said adjusting units having an identical construction with the exception of pressure rollers and intermediate pieces provided only on the application side of the disc brake.

56. Disc brake according to claim 38, further comprising a set of roller bellows arranged between ends of each intermediate piece facing the brake disc and the caliper wall which accommodates the intermediate piece.

57. Disc brake according to claim 44, wherein each bore in the pistons is closed by a sealing washer on a side facing the brake pads.

58. Disc brake according to claim 39, further comprising an antirotation protection device for the pistons, while device is provided by corresponding devices for an antirotation protection between brake pad holding plates of the brake pads and the pistons.

59. Disc brake according to claim 39, wherein bellows are provided for covering a gap between a circumference of the pistons and the caliper at an end area of the pistons facing the brake disc.

60. Disc brake according to claim 59, wherein in the gap between the circumference of the pistons and the caliper, in each case, a surrounding sealing ring 81 is provided for sealing-off the pressure chamber.
